(19) United States
(12) Patent Application Publication
(10) Pub. No.: US 2018/0361407 A1
(43) Pub. Date: Dec. 20, 2018

(54) FLUID DISPENSING APPARATUS AND METHOD

(71) Applicant: Kelli STEWART, Barrie (CA)

(72) Inventor: Kelli STEWART, Barrie (CA)

(21) Appl. No.: 16/109,284

(22) Filed: Aug. 22, 2018

Related U.S. Application Data
(63) Continuation of application No. 14/210,794, filed on Mar. 14, 2014, now abandoned.
(60) Provisional application No. 61/791,734, filed on Mar. 15, 2013.

(51) Int. Cl. B05B 7/24; B05B 7/00

(52) U.S. Cl. CPC B05B 7/2467; B05B 7/0093

(57) ABSTRACT

A portable fluid dispensing apparatus has a reservoir, a dispenser, and a pump for pressurizing the fluid in the reservoir. The dispenser may be a spray wand. The pump is a hands-free pump such that an operator can hold a dog with one hand, the spray wand with the other hand, and yet still operate the pump, as by using a foot pedal. The apparatus is self-contained, such that there is no need for an external water or electrical power hook-up.

This application is a continuation of U.S. patent application Ser. No. 14/210,794, filed Mar. 14, 2014, which claims the benefit of the priority of U.S. Provisional Patent Application Ser. No. 61/791,734 filed Mar. 15, 2013, the specifications and drawings thereof being incorporated in their entirety herein by reference.

### FIELD OF INVENTION

This application relates to a tool for holding dispensing fluid, and operation thereof.

### BACKGROUND OF THE INVENTION

When a dog is taken for a walk, particularly in wet weather, the dog may come back to the house or car rather dirty, and frequently both wet and dirty. Alternatively, one may have taken the dog in the car to a park, perhaps some distance from home. It may not necessarily be desirable to load a wet, smelly, mud-covered dog into the back of the car. Yet one may be far from a hose or other source of water with which to rinse the dog off. It is not merely a matter of the paws of the dog being dirty. The mud may be all over the dog's legs, and along its belly. It may be at a time of year when one has closed off the outside water pipes to prevent them from freezing, such that hosing the dog down may not be practical during pre-winter, winter, and pre-spring months. It may be at the beach, or on a trail run where there is no access to water for washing or cooling down the dog upon return to the car.

Whatever the reason may be, one may wish to rinse the dog off. It may not necessarily be a question of washing the dog, e.g., as with soap. It may be merely a question of rinsing the mud off. Removing the mud from the dog is not necessarily a trivial task, particularly with a long-haired dog. Rinsing a dog with a hose, while traditional, tends to require a connection to a hose or faucet. Another traditional method involves the bath-tub, but this usually requires getting a dirty dog to the tub first. The dog may be large. It may be difficult to wrestle the dog through the house up to the bath-tub. Buckets of water may be useful for rinsing a dog's paws, but less helpful, or not helpful at all, for rinsing the thighs or chest of the dog. A wet tub may not be helpful with a medium or large-sized dog. If the dog were inclined to stand still, as under a shower nozzle, while being rinsed, the task might be somewhat simplified. However, some dogs may not necessarily wish to stand still while being rinsed. Indeed, many dogs may not wish to be sprayed with water at all, and may tend to move away. Typically, this means that the dog owner (or other attendant as may be), may need to hold onto the dog with one hand, and spray the dog with a hose or nozzle held in the other hand. It may take a surprisingly high level of skill, dexterity, and agility, to manage these tasks simultaneously without becoming soaked oneself.

### SUMMARY OF INVENTION

The following summary is provided to introduce the reader to the more detailed discussion to follow. The summary is not intended to limit or define the claims.

According to an aspect of the invention there is a self-contained, portable rinsing apparatus having a fluid reservoir, a hand held sprayer connected to dispense fluid from the reservoir; and a hands-free manual pump operable to urge fluid from the reservoir to flow to the sprayer. In another aspect of the invention there is a portable fluid dispensing apparatus. It has a portable reservoir in which to contain a quantity of fluid to be dispensed. There is a dispenser operably connected to the reservoir. A hands-free pump is operable to influence pressure inside the reservoir relative to external ambient. The pump is accessible during operation of the dispenser.

In a feature of that aspect of the invention, the portable reservoir is mounted in a harness. In another feature, the portable reservoir is wheeled. In still another feature, the portable reservoir includes a flexible bladder. In another feature there is a bladder restraint. In still another feature, the dispenser includes a multi-degree-of-freedom spray head. In a further feature, there is a flexible conduit is connected to convey fluid from the reservoir to the spray head. In another feature, the dispenser includes a multi-positionable spray wand, the wand having a hand grip portion and an outlet distant from the hand grip portion. In an additional feature, the wand has a flow governor associated with the hand grip, whereby an operator holding the hand grip is able to control discharge of fluid from the outlet. In still another feature, the pump is separate from the reservoir and operatively connected to pressurize the reservoir; the pump being operable independently of the dispenser. In another feature the pump is manually powered. In still another feature the pump includes a treadle. In yet another feature, the treadle is connected to the reservoir by a flexible conduit. In still another feature, the pump is an air pump. In a further feature, the pump is operable to achieve a pressure of greater than 40 psig in the reservoir. In still another feature, the reservoir has a pressure limit of less than 120 psig.

In yet another feature, the dispenser includes a wand, the wand having a hand grip and a spray head. A flexible conduit is connected to convey fluid from the reservoir to the spray head. The pressure control includes a treadle operated air pump. The air pump is connected to the reservoir by a flexible conduit. In another feature the pump is manually powered. In again another feature, the dispenser includes a multi-positionable spray wand. The wand has a hand grip being distant from the outlet. The wand has a flow shut-off valve associated with the hand grip, whereby an operator holding the hand grip is able to control discharge of fluid from the outlet. In a further feature, the apparatus includes a harness by which to carry the apparatus upon the operator's back.

In another aspect of the invention there is a fluid dispensing apparatus. It has a man-portable reservoir. There is a dispensing wand connected to the reservoir by a flexible conduit. The wand has a hand grip and an outlet nozzle distant from the hand grip. A treadle-operated air pump. The treadle of the air pump is operatively connected to the reservoir by a flexible member.

In another aspect of the invention is the use of any combination of the foregoing aspects and features for washing animals, and, specifically, dogs.

In another aspect of the invention is a method of rinsing an animal, such as a dog, in which the steps include any combination of the steps described below by which an operator may use the rinsing apparatus while holding a dog (or other animal) with one hand, a spray wand with the other, and operating a hands-free pressurization system, such as a manual pump, at the same time to maintain the pressure in the spray directed toward such dog (or other animal).

### BRIEF DESCRIPTION OF THE ILLUSTRATIONS

The foregoing aspects and features of the invention may be explained and understood with the aid of the accompanying illustrations, in which:

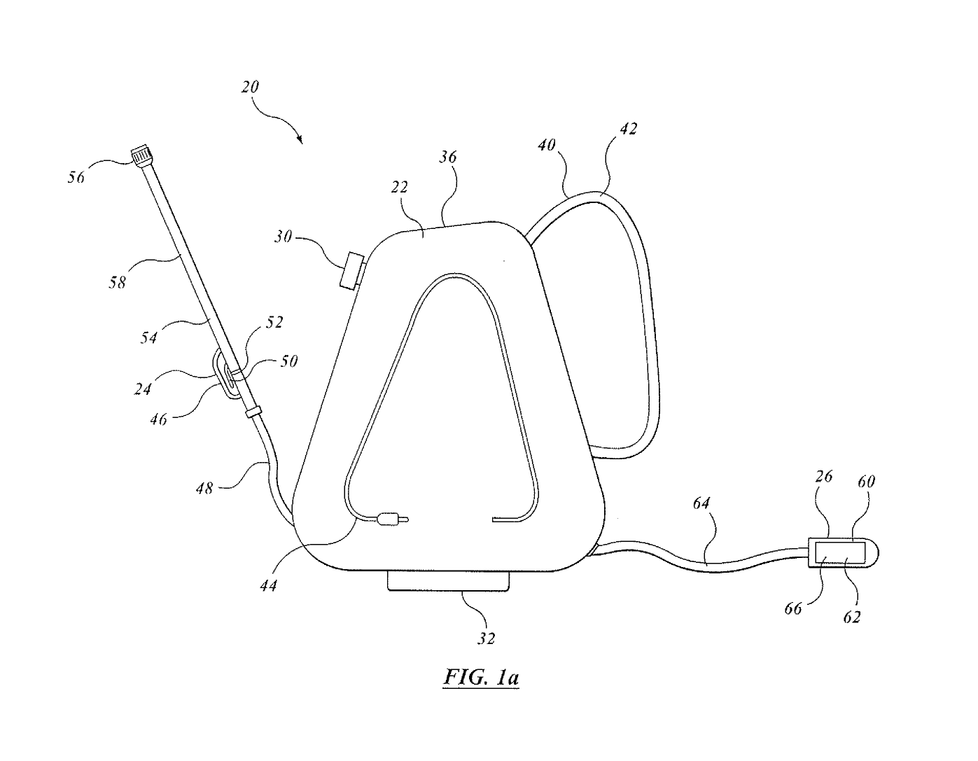

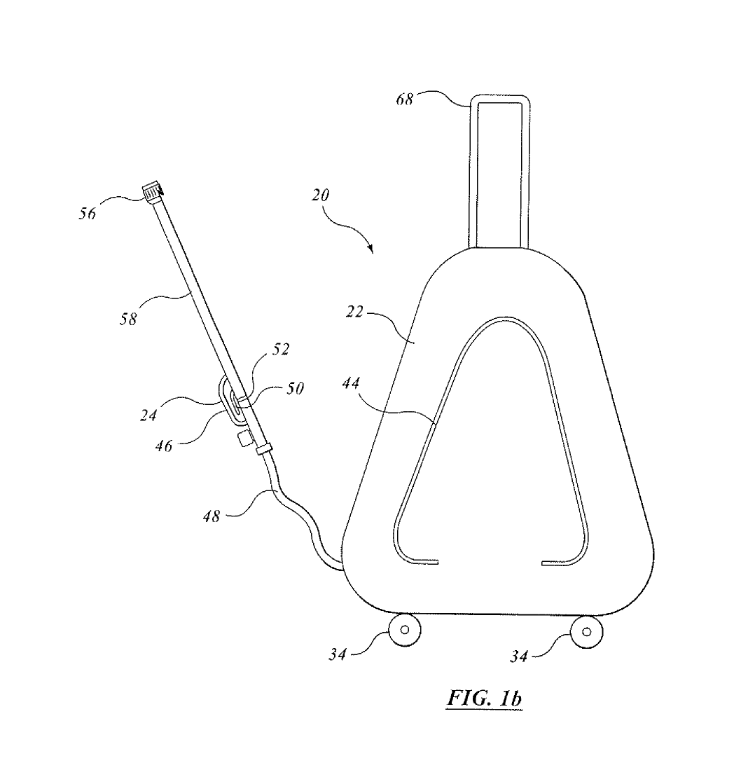

FIG. 1a is a general arrangement view of a fluid dispensing apparatus according to an aspect of the invention herein;

FIG. 1b is a rolling version of the fluid dispensing apparatus of claim 1a;

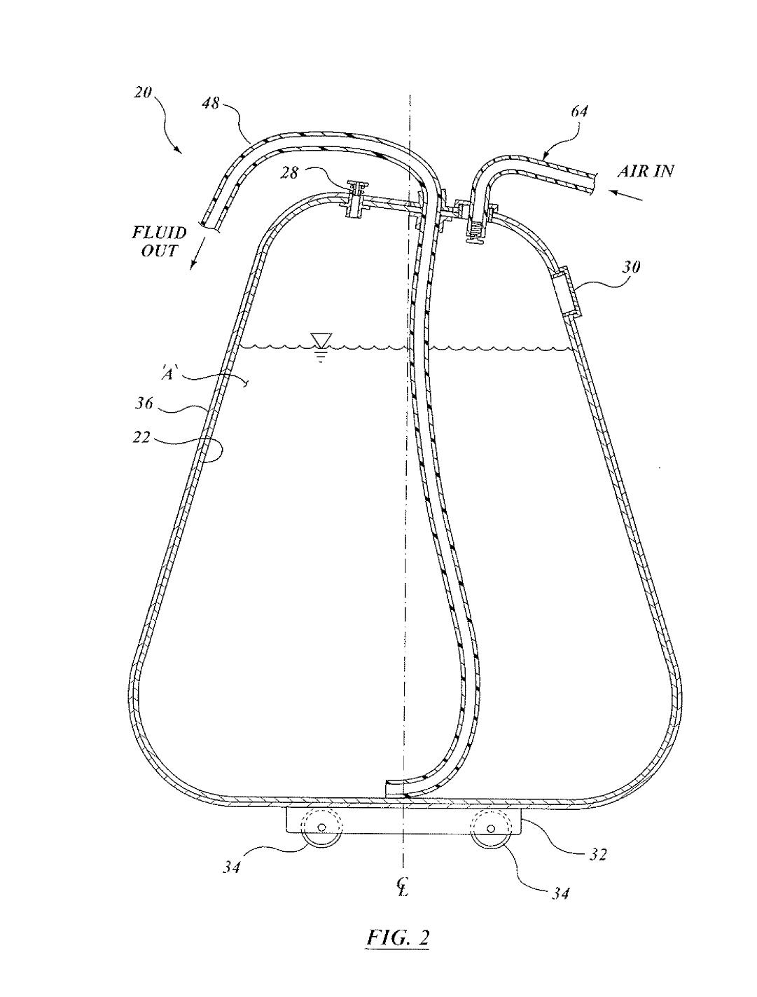

FIG. 2 is a cross-sectional view of a reservoir of the apparatus of FIG. 1a;

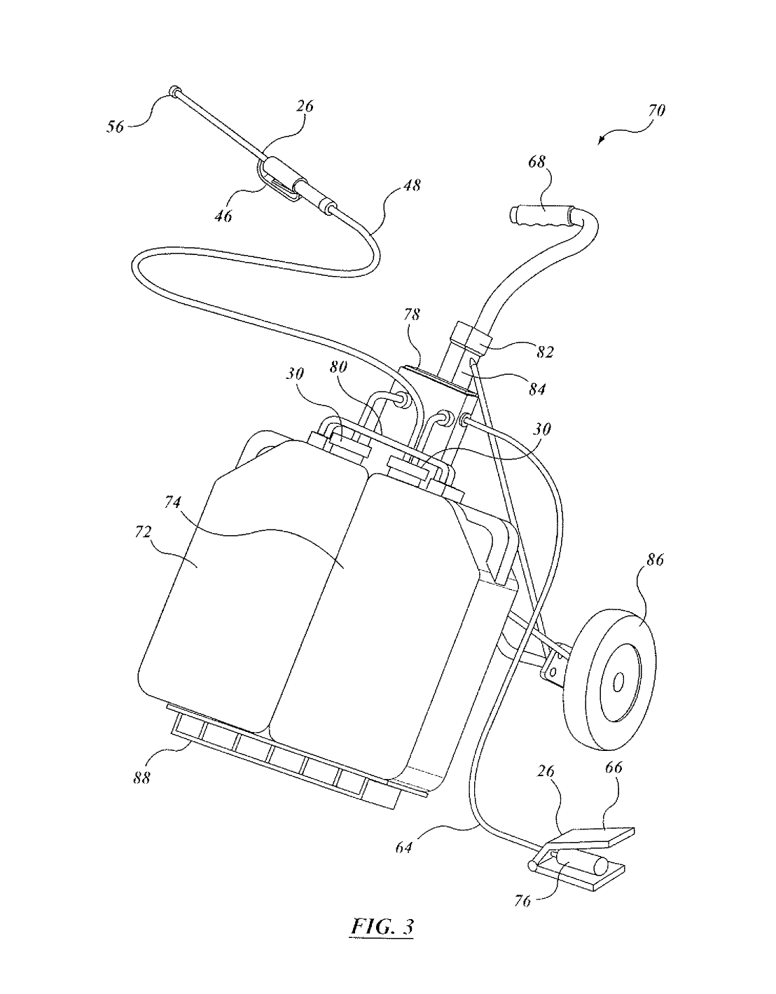

FIG. 3 shows an alternate embodiment of fluid dispensing apparatus to that shown in FIG. 1a; and

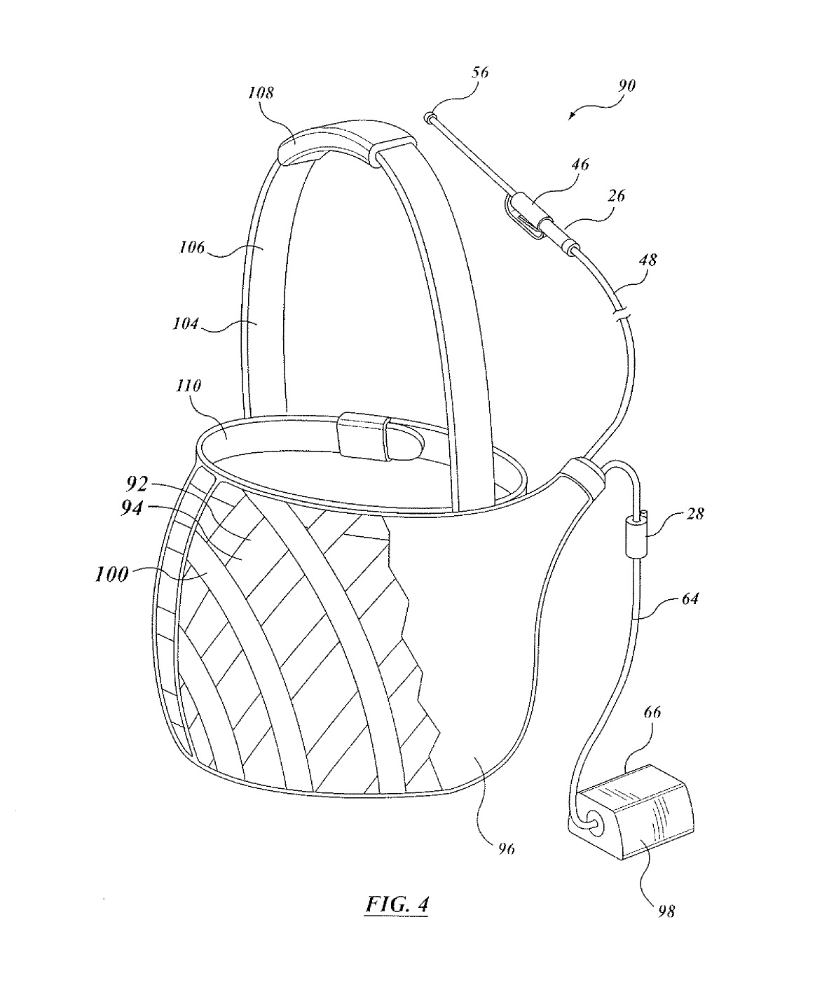

FIG. 4 shows a further alternate embodiment of fluid dispensing apparatus to that shown in FIG. 1a.

### DETAILED DESCRIPTION

The description that follows, and the embodiments described therein, are provided by way of illustration of an example, or examples, of particular embodiments of the principles of aspects and features of the invention. These examples are provided for the purposes of explanation, and not of limitation, of those principles and of the invention. In the description, like parts are marked throughout the specification and the drawings with the same respective reference numerals. The drawings may be taken as being to scale, or generally proportionate, unless indicated otherwise.

The scope of the invention herein is defined by the claims. Though the claims are supported by the description, they are not limited to any particular example or embodiment, and any claim may encompass processes or apparatuses other than the specific examples described below. Other than as indicated in the claims themselves, the claims are not limited to apparatus or processes having all of the features of any one apparatus or process described below, or to features common to multiple or all of the apparatus described below. It is possible that an apparatus or process described below is not an embodiment of any claimed inventions.

The terminology used in this specification is thought to be consistent with the customary and ordinary meanings of those terms as they would be understood by a person of ordinary skill in the art in North America. Following from the decision of the Court of Appeal for the Federal Circuit in Phillips v. AWH Corp., the Applicant expressly excludes all interpretations that are inconsistent with this specification, and, in particular, expressly excludes any interpretation of the claims or the language used in this specification such as may be made in the USPTO, or in any other Patent Office, other than those interpretations for which express support can be demonstrated in this specification or in objective evidence of record in accordance with In re Lee, (for example, earlier publications by persons not employed by the USPTO or any other Patent Office), demonstrating how the terms are used and understood by persons of ordinary skill in the art, or by way of expert evidence of a person or persons of experience in the art.

By way of general overview, a fluid dispensing apparatus is indicated in FIG. 1 generally as 20. It includes a reservoir 22 in the form of a bladder or tank having an internal chamber in which cleaning fluid ‘A’ may be contained. Cleaning fluid ‘A’ may typically be water. The reservoir has an outlet, or sprayer, or dispenser, or dispenser assembly, however it may be called, indicated generally as 24, and a pressurizing or pressure control apparatus, indicated generally as 26. The tank or reservoir 22 may also have a pressure relief valve 28 and a filler opening and pressure-sealing filler cap 30.

Reservoir 22 may have a base or footing 32 upon which reservoir 22 may sit when placed on the ground, such as when being filled. Footing 32 may include a sliding skid or rollers 34 such as may permit reservoir 22 to be moved along the ground, should that be desired. Base or footing 32 may provide a stand to hold the pack, i.e., reservoir 20, in an upright position when placed on the ground. Footing 32 may be flat, or may include protruding feet or studs such as may be more suitable for uneven or soft ground.

Reservoir 22 may be a stand-alone, substantially rigid, pressure vessel. Alternatively, apparatus 20 may include a jacket, or external carcase or harness 36 into which reservoir 22 may fit. In such an instance, reservoir 22 may have the form of a removable, heavy-duty, collapsible bag, which may be made of a plastic or rubber material, or the like. When the closure member, such as zipper 44, is undone, the bag may be removed from the jacket or carcase or harness 36 for filling, or it may be filled in-place through filler cap 30. In the embodiment employing a bag, when the unit is empty, the flexible liner, or bag, may be folded or rolled up for storage inside the carcase, which, if also collapsible, may also be folded or collapsed for storage.

Although each fitting may have its own dedicated wall penetration of reservoir 22, as shown in FIG. 1 for generality, to the extent that punctures or penetrations in pressurized structures may be desirably few in number, it may be that the connection 38 of the wand assembly of dispenser 24 may be part of, or attached to, the filler cap, or filler cap assembly, such that there is a single wall penetration in reservoir 22, and pressure relief valve 28 may be on an, or the, outlet line emanating from filler cap 30, rather than having its own wall penetration. In some embodiments apparatus 20 may include one or more lifting members 40 attached to harness 36. Those lifting members may include one or more shoulder straps 42, such that reservoir 22 may be slung over the operator's shoulder, or, in the further alternative, where there are two such shoulder straps, reservoir 22 may be carried on the operator's back in the manner of a back-pack.

Dispenser 24 includes a handle 46 that is in fluid communication with reservoir 22. The fluid communication may be by means of a flexible pressure hose 48 which conveys fluid under pressure from reservoir 22 to handle 46. Pressure hose 48 may be of a suitable length for washing a dog. That is to say, to the extent that handle 46 is a multi-degree-of-freedom handle (that is, hose 48 permits it to be positioned at more or less any angle and facing in any orientation), a suitable length may be a length that approximates the length of a person's arm, that distance being historically approximately the same distance as one English yard. That is, a length between about 30 inches and four feet may give the desired range of flexibility and manoeuvrability.

In some embodiments, handle 46 may include a pressure gauge. Handle 46 may also include a flow governor, or valve, such as a shut-off valve 50 which may be controlled from the hand grip of handle 46, whether by a trigger or by a squeezable lever 52 in the manner of a garden hose nozzle handle, for example, that is movable between first and second, or open and closed, positions. In the usual manner, when activated, or opened, fluid is permitted to flow, and when closed the fluid is retained in reservoir 22. Handle 46 may have the form of, or be part of, a wand or wand assembly 54, which may include the squeezable lever 52, and an outlet in the form of a spray nozzle 56. Wand assembly 54 may include an extension 58, in the form of a length of tube, with nozzle 56 being at the end thereof. The extension tube may be a flexible polymer tube. Nozzle 56 may be adjustable (e.g., by angular rotation in the manner of a garden or other nozzle) to vary the focus of the outlet spray.

Reservoir 22 may be of any size that is reasonably portable. For an apparatus that is carried on the wearer's back, reservoir 22 may have a capacity of up to 5 gal., or about 50 lbs. weight, when filled with water. Smaller capacity tanks such as 10, 12, or 15 liters, could also be used. A tank with rollers, that is not intended to be worn by the operator, may be larger. However, for most dogs a three or four gallon supply of water may be satisfactory.

Pressure control apparatus 26 may include a pump 60, a pump actuator 62, and a uni-directional flow pressure line 64 extending from pump 60 to reservoir 22. Pump 60 may be a manually operated air pump, i.e., a pump that is free of an external power source such as an electrical power source. In this instance actuator 62 is a foot pad or treadle 66, such as may be acutated by an operator pushing down on treadle 66 with their foot. In a mechanical embodiment, a spring may return the footplate of treadle 66 to its initial position when the operator's reduces pressure thereupon. The foot actuator, i.e., treadle 66, may be distant from reservoir 22. For example, when reservoir 22 is worn on the operator's back, treadle 66 is several feet from reservoir 22, such that treadle 66 is on the ground. That distance may be of the order of the height of a person, or perhaps somewhat more, such as 6 or 8 feet. For a rolling unit, a shorter air hose may be used, or, alternatively, the treadle may be mounted to the base of the unit, or beside the unit and connected by its air line, but nonetheless accessible and operable by an operator standing adjacent to reservoir 22. The foot actuator may be operated even when the operator cannot reach the reservoir, either because, for example, reservoir 22 is worn on the operator's back, or because the operator has one hand holding a dog, and another hand using the wand to spray the dog. The pump is therefore a “hands-free” pump. The operator can continue to actuate the pump while spraying the dog. The pumping action of the foot pedal or treadle, 66, is used to build up the required pressure in reservoir 22 to yield a strong jet of water such as may be used in removing clods of mud from a dog, whether the dog is large or small.

Apparatus 20 may include a towing handle 68, which, as in the embodiment of Figure la, may be a telescoping lifting and towing handle (that is, in the closed position it may be latched as a lifting handle, and in the extended position it may be used for towing.

As shown, there is a rinsing apparatus 20 that may be used, primarily, to rinse dirt, mud, sand or debris from dogs. The person washing the dog may desire a source of pressurized water, with the ability to maintain pressurization without either (a) letting go of the dog; or (b) letting go of the spray wand. Without apparatus 20, controlling pressure at the same time might then present something of a challenge. It may also be that it may be inconvenient for the operator to need to be near a powered pump that requires either an electrical connection, or heavy batteries, or connection to an internal combustion engine—particularly if one is at the park, or wishes to rinse off the dog out on the grass. Apparatus 20 is portable. It is, relatively, light-weight. In one embodiment it is operated by a foot pump.

After a jaunt, the portable rinsing unit may be used to rinse dirt, sand, and so on from ones dogs when returning from a walk, run, hike, beach or any activity outside that may cause the dog to get dirty. When equipped with wheels it can be pulled or towed. When equipped with back straps it can be carried like a backpack. The unit is used prior to returning home, e.g., prior to bringing the dog in the house or prior to loading the dog into the car. The rinsing unit, i.e., apparatus 20, may also be used to wash a dog if combined with rinse-less shampoo. However, the primary function of apparatus 20 may be rinsing, and a dog may be rinsed with or without shampoo.

Being a portable unit, the unit does not require attachment to a hose or faucet to dispense water. It does not require attachment to a stationary watering system to function. The unit may be moved to the front porch or to the back porch, or to such location as may be convenient at home. The unit may be taken in the car and used to rinse off the dog after leaving the beach, trail, or park. Although useful for rinsing, the unit may also be used for cooling, e.g., to rinse a dog (or horse) off in the heat after a run, jog, or walk in the summer months.

Further too, and unlike a cold water tap, prior to setting out on a jaunt or outing with the dog one may fill reservoir 22 with water of a suitable temperature (e.g., cold in the summer; warm in the winter), and leave it by the door of the house, or loaded in the car, such that it is ready for use upon return. Upon arrival the unit is rolled out, or carried on the back like a back pack. Both hands are free, so one hand can hold Rover, and one hand can spray.

Although a foot pump is shown and described, and has the advantage of not requiring an electrical power source, and is therefore operable independently of the existence of such a source, in another embodiment the pump may be electrically operated. In one embodiment the pump is operated by batteries. In another embodiment it may be operated from a 12V outlet from an automobile, such as a cigarette lighter. In still another embodiment it may be operated from a standard electrical plug, e.g., single phase 120 V, 60 Hz, in North America, 220 V 50 Hz in Europe. In a battery operated unit, or a unit having an electric pump, whether battery operated or plug-in, the battery or pump may be mounted in the base. That is, base or footing 32 may be made of hard plastic, and defines within it a battery pack housing, and an air pump as may be. Where an electric pump is used, foot treadle 66 may still be used as an actuator switch for the pump, such that the pump remains a “hand-free” pump that may be operated while holding a dog with one hand and using the other hand to operate the spray wand. Alternatively, in an electric pump unit, the “on” switch may be located on the unit, and a pressure sensor may be used, such that the pump automatically turns on when the pressure is below a first threshold value, such as 60 psig, and turns off if tank pressure is above a second threshold value, such as 80 or 100 psig, with an electric power cut off when the back-up pressure regulator activates at 120 psig, for example. In such an embodiment the pump remains “hands-free” during the rinsing process, i.e., the person struggling with the dog does not need a third hand to operate the pump.

There may be more than one pressure relief valve 28, either one with a low setting and another with a high setting, or in a pairing such as may give redundancy in the event of failure. Relief valve 28 may be set to whistle when open, such as to alert the user. In this task it may be helpful to have a sprayer of some kind. Municipal water pressure from a hose, which may be, typically, 35-40 psig, may not be sufficient to break up clumps of mud in the dog's fur. It may be desirable to have a higher pressure, but not so high a pressure as to be painful to the dog. The spray or jet may be adjusted by the operator accordingly. In one embodiment the pressure relief may be set at 100 psig, with a backup relief at 120 psig. In another embodiment the pressure relief may be set at 80 psig. That is, the operating pressure of the device is in the range above 40 psig and below 100 psig or 80 psig., according to the pressure setting of the relief valve, or according to the pressure indicated on the pressure gauge on the wand assembly, which (if used) is visible to the operator. The operator can tell when the pressure is at its limit when the pressure regulator whistles or hisses on releasing air. The operator can control the strength of the fluid jet or spray by manipulating the squeeze handle or by adjusting the focus of the nozzle (prior to operation while the flow is shut off), or both. For example, a gentle spray may be used to soak dirty portions of the dog initially; a stronger, more tightly-focused spray may be used to dislodge mud that has previously been moistened.

In the embodiment of FIG. 3, there is a fluid dispensing apparatus 70 in which there are first and second tanks or reservoirs 72, 74 not unlike jerricans. Reservoirs 72 and 74 are ganged together such that pressurization from pump 76 pressurizes both.

Alternatively, a control unit, such as a manually operated manifold valve, contained within unit 78, may be used for this purpose. In other respects each of reservoirs 72, 74 may be like reservoir 22, in terms of having a filler cap 30, pressure relief 28, and co-operable connection either to the other tank as at 80, or to the dispensing wand assembly 38. Apparatus 70 may include a carriage 82, which may be a collapsible carriage 84 with a wheel-folding mechanism such as used on a cart for carrying golf clubs, and in which case towing handle 68 in this embodiment is a foldable handle of carriage 84, that, when extended, may be towed in the same manner as a golfer tows golf clubs. The undercarriage may include wheels 86. Wheels 86 may be relatively large, such as to permit operation over relatively soft ground, such as wet turf, a beach, and so on. Reservoirs 72, 74 are disengageable from their seat 88 on carriage 84 to permit filling. Carriage 84 and towing handle 68 may be folded and loaded into the back of the car. Use of multiple reservoirs may permit smaller, and therefore individually less heavy, reservoirs to be used. Alternatively, whether reservoirs 72, 74 are individually smaller or not, use of multiple reservoirs may permit greater capacity, either for dealing with an especially dirty dog or for dealing with more than one dog. Arrangements with three, four, or more reservoirs are possible.

In the embodiment of FIG. 4, apparatus 90 may have a reservoir 92 may also have the form of an inflatable bladder 94 removably mounted within a containment jacket 96, the bladder being contained within jacket 96 when pressurized by use of foot pump 98. The filler cap 30 is also the access point for both pressurization and for outflowing fluid to be dispensed. The jacket may include stiffening reinforcements, and may, like a car-tire, include a lattice work of webbing 100 for containing the pressurized bladder. In this example a pressure relief valve 102 may be located on either the inlet or the outlet line (i.e., upstream of the shut-off valve in wand assembly 38). In this type of embodiment the jacket functions much in the manner of a car tire with an inner tube mounted therewithin. A harness 104 may include a shoulder strap 106 with load-spreading pad 108, and may include an adjustable belt 110 such as may be work about the waist to discourage bladder 94 from swinging inopportunely during use.

The fluid used may be water, or it may be water with a soap or a cleaning powder. Although intended for dogs, a spray dispenser such as described may be used for other kinds of animals, such as horses, cows, pigs, and so on. It may also be used in other applications where a pressurized fluid is required.

What has been described above has been intended illustrative and non-limiting and it will be understood by persons skilled in the art that other variances and modifications may be made without departing from the scope of the disclosure as defined in the claims appended hereto. Various embodiments of the invention have been described in detail. Since changes in and or additions to the above-described embodiments may be made without departing from the generality of the invention, the invention is not to be limited to those details but only by the appended claims.

I claim:

1. A self-contained, portable rinsing apparatus having a fluid reservoir, a hand held sprayer connected to dispense fluid from the reservoir; and a hands-free manual pump operable to urge fluid from the reservoir to flow to the sprayer.

2. A portable fluid dispensing apparatus comprising:
a portable reservoir in which to contain a quantity of fluid to be dispensed;
a dispenser operably connected to the reservoir;
a hands-free pump operable to influence pressure inside said reservoir relative to external ambient;
said pump being accessible during operation of the dispenser.

3. The fluid dispensing apparatus of claim 2 wherein said portable reservoir is mounted in a harness.

4. The fluid dispensing apparatus of claim 2 wherein said portable reservoir is wheeled.

5. The fluid dispensing apparatus of claim 2 wherein said portable reservoir includes a flexible bladder.

6. The fluid dispensing apparatus of claim 2 wherein said dispenser includes a multi-degree-of-freedom spray head.

7. The fluid dispensing apparatus of claim 2 wherein said dispenser includes a multi-positionable spray wand, said wand having a hand grip portion and an outlet distant from said hand grip portion.

8. The fluid dispensing apparatus of claim 7 wherein said wand has a flow governor associated with said hand grip, whereby an operator holding said hand grip is able to control discharge of fluid from said outlet.

9. The fluid dispensing apparatus of claim 2 wherein said pump is separate from said reservoir and operatively connected to pressurize said reservoir; said pump being operable independently of said dispenser.

10. The fluid dispensing apparatus of claim 9 wherein said pump is manually powered.

11. The fluid dispensing apparatus of claim 9 wherein said pump includes a treadle.

12. The fluid dispensing apparatus of claim 11 wherein said treadle is connected to said reservoir by a flexible conduit.

13. The fluid dispensing apparatus of claim 12 wherein said pump is an air pump.

14. The fluid dispensing apparatus of claim 13 wherein said pump is operable to achieve a pressure of greater than 40 psig in said reservoir.

15. The fluid dispensing apparatus of claim 14 wherein said reservoir has a pressure limit of less than 120 psig.

16. The fluid dispensing apparatus of claim 2 wherein:
said dispenser includes a wand, said wand having a hand grip and a spray head;
a flexible conduit is connected to convey fluid from said reservoir to said spray head;
said pressure control includes a treadle operated air pump; and
said air pump is connected to said reservoir by a flexible conduit.

17. The fluid dispensing apparatus of claim 16 wherein said pump is manually powered.

18. The fluid dispensing apparatus of claim 16 wherein said dispenser includes a multi-positionable spray wand; said wand having a hand grip being distant from said outlet; and said wand has a flow shut-off valve associated with said hand grip, whereby an operator holding said hand grip is able to control discharge of fluid from said outlet.

19. The fluid dispensing apparatus of claim 16 wherein said apparatus includes a harness by which to carry said apparatus upon the operator's back.

20. A fluid dispensing apparatus comprising:
a man-portable reservoir;
a dispensing wand connected to said reservoir by a flexible conduit;
said wand having a hand grip and an outlet nozzle distant from said hand grip; and
a treadle-operated air pump, the treadle of said air pump being operatively connected to said reservoir by a flexible member.
